(19) United States
(12) Patent Application Publication
(10) Pub. No.: US 2021/0348645 A1
(43) Pub. Date: Nov. 11, 2021

(54) BEARING ASSEMBLY

(71) Applicant: AKTIEBOLAGET SKF, GOTEBORG (SE)

(72) Inventors: Martin Daucher, Ternberg (AT); Thomas Forster, Waidhofen/Ybbs (AT); Bernd Stephan, Schweinfurt (DE)

(21) Appl. No.: 17/237,589

(22) Filed: Apr. 22, 2021

(30) Foreign Application Priority Data
May 11, 2020 (DE) 102020205860.1

(51) Int. Cl. F16C 19/18; F16C 19/50

(52) U.S. Cl. CPC F16C 19/181; F16C 19/505; F16C 41/004; F16C 2240/34; F16C 2240/26; F16C 2240/70

(57) ABSTRACT

A bearing assembly for supporting a drive shaft of an electric drive motor includes at least one inner ring, at least one outer ring, and a plurality of rolling elements disposed between the inner ring and the outer ring. The bearing assembly is an angular contact ball bearing, and the plurality of rolling elements include a first row of rolling elements and a second row of rolling elements. Also a shaft assembly supported by the bearing assembly and an electric motor including the shaft assembly.

### CROSS-REFERENCE

This application claims priority to German patent application no. 10 2020 205 860.1 filed on May 11, 2020, the contents of which are fully incorporated herein by reference.

### TECHNOLOGICAL FIELD

The present disclosure is directed to a bearing assembly, in particular an angular contact bearing assembly, for supporting a drive shaft of an electric drive motor and to a shaft assembly for an electric drive motor including such a bearing assembly.

### BACKGROUND

Current electric drive motors are usually supported by paired deep groove ball bearings. Such deep groove ball bearings show a high axial clearance and are not very rigid axially. Therefore deep groove ball bearings are limited in their range of application, in particular at high rotational speeds. However, in the development of current motors, in particular electric motors, it is important to reduce the weight and the size of the motors. In order to achieve this, it would be desirable to produce motors that can run at very high speeds. Here n*dm values (rotational speed*pitch-circle diameter) of 1,000,000 mm/min or more are desired. However, the deep groove ball bearings currently used in electrical drive motors cannot withstand such high rotational speeds, or n*dm values.

### SUMMARY

It is therefore an aspect of the present disclosure to provide a bearing assembly for supporting a drive shaft of an electric drive motor, which bearing assembly is able to withstand very high rotational speeds, in particular n*dm values of 1,000,000 mm/min or higher.

This is achieved by a bearing assembly for supporting a drive shaft of an electric drive motor according to the present disclosure, as well as a shaft assembly including such a bearing assembly according to the present disclosure.

The bearing assembly includes at least one inner ring, at least one outer ring, and rolling elements that are disposed between the inner ring and the outer ring. In contrast to previous bearing assemblies including deep groove ball bearings, in order to also be able to support drive shafts of electrical drive motors with high rotational speeds, in particular with n*dm values of 1,000,000 mm/min or higher, the present bearing assembly is configured as an angular contact ball bearing including two rows of rolling elements. Due to the design as an angular contact ball bearing, the rigidity of the bearing assembly and thus of the motor can be increased. Thus the motors can be used with higher rotational speeds than is possible with the deep groove ball bearings used to date. For the sake of simplicity, in the following the n*dm values (rotational speed*pitch-circle diameter) that provide a more precise indication are referred to as rotational speeds.

In previous bearing assemblies for drive shafts, deep groove ball bearings have been used, which are indeed more economical, but only withstand low rotational speeds, in particular n*dm values of less than 700,000. However, the inventors have found that despite the higher costs, the use of angular contact ball bearings is advantageous, since these motors can be developed with higher rotational speeds. Due to these high rotational speeds, the motors can be built lighter and more compact, which outweighs the higher costs of the angular contact ball bearings. In addition to the higher rotational speeds, the angular contact ball bearings surprisingly offer the advantage that they are even more stable even at the higher rotational speeds than the deep groove ball bearings used to date. This also has the positive effect that the motors, or the drive shafts, are more stable.

The diameter of the rolling elements can in particular fall between 0.2*(D-d) and 0.4*(D-d), in particular between 0.25*(D-d) and 0.35*(D-d). D here specifies the outer diameter of the bearing assembly, and d specifies the inner diameter of the bearing assembly. The rolling elements, in particular the balls, are thus smaller than is the case with the usual angular contact ball bearings. For example, according to this embodiment the rolling-element diameter can be 0.33*(D-d) in two paired single row angular contact ball bearings, and 0.303*(D-d) in a double row angular contact ball bearing.

Due to the smaller rolling elements, the rigidity of the bearing assembly can be increased, since with smaller rolling elements more rolling elements can be used per bearing. Bearings including many small rolling elements are more rigid than those including few large rolling elements.

According to a further embodiment, the contact angle of the angular contact ball bearing is between 15° and 40°, in particular between 15° and 25°. Smaller angles can be particularly well suited for high rotational speeds, since the contact angle change caused by centrifugal force is very small, and the wear is thereby reduced.

In one embodiment the contact angles of the two rows of rolling elements can be identical to each other.

Alternatively the contact angles of the two rows of rolling elements can be different. In particular, the first row of the rolling elements has a smaller contact angle here than the second row of the rolling elements. This has the advantage that the row having the smaller contact angle generates a high radial rigidity. The row having the larger contact angle in turn generates a high axial rigidity. In this way both the radial and the axial rigidity is increased by the bearing assembly.

The bearing having the smaller contact angle should lie on the motor inner side. The radial forces are primarily supported by this bearing. Due to the inner-lying position, the support width is reduced and the shaft bending is thereby reduced.

The rolling elements can be manufactured from metal, in particular steel, or a ceramic material. The selection of the material depends in particular on the speed and the requirements for the electrical conductivity. The rolling elements are preferably manufactured from ceramic, since this protects the rolling elements, rings, and lubricant from electro-erosion.

The bearing assembly can furthermore include an electrically conducting element, in particular an electrically conducting brush, which is disposed between the inner ring and the outer ring. Such a brush can be used in particular in connection with rolling elements made of ceramic in order to electrically connect the inner and the outer ring to each other. This conducting element can thus ensure that no static voltages develop in the bearing assembly, since they can be dissipated via the connection between inner ring and outer ring. Electrostatically charged rotors represent a safety risk, since during contact the current could be discharged by a person.

According to one embodiment, the bearing assembly includes two inner rings and two outer rings, between each of which a row of rolling elements is respectively disposed. The bearing assembly is thus configured as a set of paired angular contact ball bearings, which can be disposed in back-to-back or face-to-face arrangement. The two paired single row angular contact ball bearings can additionally be preloaded in the axial direction with respect to each other by a spring.

According to another embodiment, the bearing assembly includes two inner rings and one outer ring. Such a double row angular contact ball bearing can further increase the possible rotational speeds, since it has a higher axial rigidity than a double row angular contact ball bearing including a one-part inner ring.

In general one-piece cages, which are ideal for high speeds, for example made of plastic or of metal, can be used in the bearing assembly disclosed here. The pockets of the cage can be circumferentially spaced either uniformly or unevenly. In contrast to an identical spacing, an uneven spacing has the advantage here that the ball throughflow frequency does not excite surrounding components.

According to a further embodiment, a shaft assembly for an electric drive motor is disclosed. The shaft assembly includes a drive shaft that is supported on both ends by the above-described bearing assembly.

Another aspect of the disclosure comprises an electric motor including a shaft assembly as described above and a method of operating the electric motor at a rotation rate having an n*dm value greater than 700,000 mm/min or greater than 1,000,000 mm/min.

Further advantages and advantageous embodiments are specified in the description, the drawings, and the claims. Here in particular the combinations of features specified in the description and in the drawings are purely exemplary, so that the features can also be present individually or combined in other ways.

In the following the invention is described in more detail using the exemplary embodiments depicted in the drawings. Here the exemplary embodiments and the combinations shown in the exemplary embodiments are purely exemplary and are not intended to define the scope of the invention. This scope is defined solely by the pending claims.

### BRIEF DESCRIPTION OF THE DRAWINGS

FIG. 1 is a cross-sectional view of a first embodiment of a bearing assembly for supporting a drive shaft of an electric drive motor.

FIG. 2 is a cross-sectional view of a second embodiment of a bearing assembly for supporting a drive shaft of an electric drive motor.

### DETAILED DESCRIPTION

In the following, identical or functionally equivalent elements are designated by the same reference numbers.

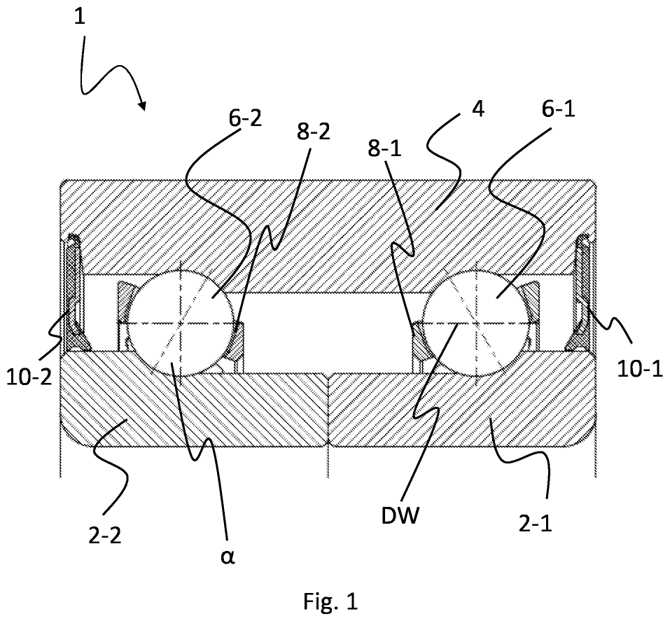

FIG. 1 shows a cross-sectional view of a first embodiment of a bearing assembly 1 for supporting a drive shaft of an electric drive motor. The bearing assembly 1 is configured as a double row angular contact ball bearing and includes a split inner ring 2-1, 2-2. The bearing assembly 1 furthermore includes a single, common outer ring 4. Two rows of rolling elements 6-1 and 6-2 are disposed between the split inner ring 2-1, 2-2 and the outer ring 4.

Due to the use of an angular contact ball bearing 1 for supporting a drive shaft of an electric drive motor, higher rotational speeds can be realized in the motor than were possible with previous bearing assemblies that use deep groove ball bearings. Due to the use of the angular contact ball bearings 1, it is possible for the drive shaft and thus the motor to be operated at very high rotational speeds up to 1,500,000 mm/min, or even higher. With the deep groove ball bearings used to date, only rotational speeds of up to 700,000 mm/min could be achieved. Due to the higher rotational speeds, the motor can be built smaller and lighter in comparison to previous motors.

In the angular contact ball bearing 1 depicted in FIG. 1, the contact angle α=30°. Instead of two identical contact angles as is shown here, different contact angles can also be used. This has the advantage that the row having the smaller contact angle generates a greater radial rigidity, while the row having the larger contact angle generates a greater axial rigidity.

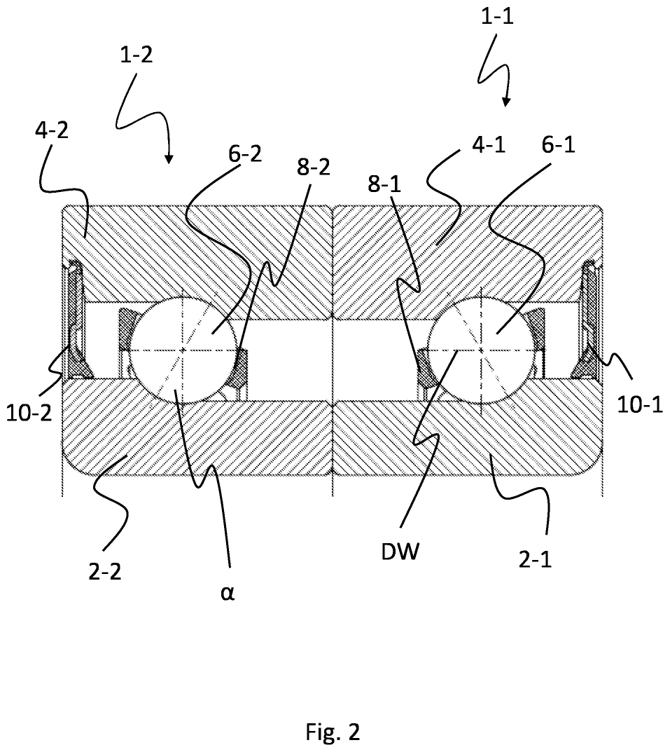

The angular contact ball bearing 1 is used to support a drive shaft of an electric drive motor. For this purpose the drive shaft is supported on each end by a bearing assembly, as is depicted in FIG. 1 or FIG. 2. The inner rings 2-1, 2-2 of the angular contact ball bearing 1 are disposed on the drive shaft, whereas the outer rings 4 are disposed in a housing of the drive motor in order to support the drive shaft in the housing.

In comparison to conventional angular contact ball bearings, the diameter D_{W} of the rolling elements 6-1, 6-2 is selected smaller. In particular, the diameter D_{W} in such a double row angular contact ball bearing 1 can be 0.303*(D-d), wherein D is the bearing outer diameter and d is the bearing inner diameter.

The rolling elements 6-1, 6-2 can be held by respective cages 8-1, 8-2. In particular, these can be one-piece cages. The cages 8-1, 8-2 can be manufactured from plastic or from metal. Outwardly the bearing assembly 1 can be sealed by respective seal assemblies 10.

Instead of a double row angular contact ball bearing, two single row angular contact ball bearings 1-1, 1-2 can also be used, as is depicted in FIG. 2. Here the two single row angular contact ball bearings 1-1, 1-2 are installed in pairs. In contrast to the double row angular contact ball bearing 1 of FIG. 1, in this case the angular contact ball bearing 1 is thus configured with two inner rings 2-1, 2-2, and two outer rings 4-1, 4-2.

In the embodiment depicted, the two angular contact ball bearings 1-1, 1-2 are depicted in a back-to-back arrangement. Alternatively the two single row angular contact ball bearings 1-1, 1-2 can also be installed in a face-to-face arrangement.

In this case the diameter D_{W} of the rolling elements 6-1, 6-2 can preferably be 0.33*(D-d). The rolling elements 6-1, 6-2 can be held by respective cages 8-1, 8-2.

In this bearing assembly 1 the contact angle α is also 30°. However, it should be noted that the contact angle of the angular contact ball bearing of FIG. 1 and FIG. 2 can be between 15° and 40°. A smaller contact angle has the advantage that the bearing assembly 1 can withstand higher rotational speeds. The contact angle α can also differ between the two rolling-element rows 6-1, 6-2. The row having the smaller contact angle increases the radial rigidity, whereas the row having the larger contact angle increases the axial rigidity.

As explained above, the disclosed bearing assembly makes it possible to realize very high rotational speeds of 1,400,000 or mm/min or 1,500,000 mm/min or higher in motors in which the bearing assembly is used for supporting the drive shaft. This is achieved by using angular contact ball bearings instead of the previous deep groove ball bearings. Due to these high rotational speeds, the motors can in turn be built lighter and more compact.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved bearing assemblies for electric motors.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Bearing assembly
2 Inner ring
4 Outer ring
6 Rolling elements
8 Cage
10 Seal assembly
α Contact angle
D_{W} Rolling-element diameter

What is claimed is:

1. A bearing assembly for supporting a drive shaft of an electric drive motor, the bearing assembly comprising:
at least one inner ring,
at least one outer ring, and
a plurality of rolling elements disposed between the inner ring and the outer ring,
wherein the bearing assembly comprises an angular contact ball bearing, and
wherein the plurality of rolling elements comprise a first row of rolling elements and a second row of rolling elements.

2. The bearing assembly according to claim 1,
wherein a diameter of the plurality of rolling elements falls between 0.2*(D-d) and 0.4*(D-d), where D is an outer diameter of the bearing assembly, and d is an inner diameter of the bearing assembly.

3. The bearing assembly according to claim 1,
wherein a diameter of the rolling elements falls between 0.25*(D-d) and 0.35*(D-d), where D is an outer diameter of the bearing assembly, and d is an inner diameter of the bearing assembly.

4. The bearing assembly according to claim 1,
wherein a contact angle of the angular contact ball bearing falls between 15° and 40°.

5. The bearing assembly according to claim 1,
wherein a contact angle of the angular contact ball bearing falls between 15° and 25°.

6. The bearing assembly according to claim 1, wherein a contact angle of the first row of rolling elements is different than a contact angle of the second row of rolling elements.

7. The bearing assembly according to claim 1
including an electrically conducting brush disposed between the inner ring and the outer ring.

8. The bearing assembly according to claim 1,
wherein the at least one inner ring comprises a first inner ring and a second inner ring,
wherein the at least one outer ring comprises a first outer ring and a second outer ring,
wherein the first row of rolling elements is disposed between the first inner ring and the first outer ring, and
wherein the second row of rolling elements is disposed between the second inner ring and the second outer ring.

9. The bearing assembly according to claim 1,
wherein the at least one inner ring comprises a first inner ring and a second inner ring,
wherein the at least one outer ring comprises no more than one outer ring,
wherein the first row of rolling elements is disposed between the first inner ring and the outer ring, and
wherein the second row of rolling elements is disposed between the second inner ring and the outer ring.

10. A shaft assembly for an electric drive motor, comprising:
a shaft supported on both ends by a bearing assembly according to claim 1.

11. An electric motor comprising the shaft assembly according to claim 10.

12. A method comprising:
operating the electric motor according to claim 11 at a rotational speed having an n*dm value greater than 700,000 mm/min.

13. A method comprising:
operating the electric motor according to claim 11 at a rotational speed having an n*dm value greater than 1,000,000 mm/min.

14. The bearing assembly according to claim 1,
wherein a diameter of the plurality of rolling elements falls between 0.2*(D-d) and 0.4*(D-d), where D is an outer diameter of the bearing assembly, and d is an inner diameter of the bearing assembly, and
wherein a contact angle of the angular contact ball bearing falls between 15° and 40°.

15. A shaft assembly for an electric motor comprising:
a shaft supported on both ends by a bearing assembly according to claim 14.

16. An electric motor comprising the shaft assembly according to claim 15.

17. A method comprising:
operating the electric motor according to claim 16 at a rotational speed having an n*dm value greater than 700,000 mm/min.

18. A method comprising:
mounting the shaft assembly according to claim 16 in an electric motor, and
operating the electric motor at a rotational speed having an n*dm value greater than 1,000,000 mm/min.
